(19) United States
(12) Patent Application Publication
(10) Pub. No.: US 2018/0349351 A1
(43) Pub. Date: Dec. 6, 2018

(54) Systems And Apparatuses For Rich Phrase Extraction

(71) Applicant: Move, Inc., Westlake Village, CA (US)

(72) Inventors: Anurag Singhal, Westlake Village, CA (US); Neeraj Garg, Westlake Village, CA (US); Niti Sharma, Westlake Village, CA (US); Ketan Vala, Westlake Village, CA (US); Rohan Attravanam, Westlake Village, CA (US); Zeeshan Sajid, Westlake Village, CA (US); Rahul Sambari, Westlake Village, CA (US); Marina Lopatiouk, Westlake Village, CA (US)

(21) Appl. No.: 15/994,793

(22) Filed: May 31, 2018

Related U.S. Application Data
(60) Provisional application No. 62/513,402, filed on May 31, 2017.

(51) Int. Cl. G06F 17/27; G06F 17/30; G06F 15/18

(52) U.S. Cl. CPC G06F 17/277; G06F 17/2775; G06F 15/18; G06F 17/30705; G06F 17/30696; G06F 17/274

(57) ABSTRACT

Apparatuses, methods, and systems disclosed herein that extracts grammatically meaningful phrases from property listing descriptions. In one example embodiment, a method is provided comprising receiving property descriptions, identifying phrase candidates by: parsing each phrase candidate into a set of word tokens, tagging each word token, and grouping the set of word tokens. Thereafter, computing a score for each phrase candidate and providing a list of property description recommendations comprising one or more phrase candidates with a high ranking score. The method further comprises predicting, via a machine learning algorithm, future trend value of each of the property description recommendations based on results from a plurality of historical property descriptions, and causing to display the list of property description recommendations in an order according to the predicted future trend value.

### CROSS-REFERENCE TO RELATED APPLICATIONS

This application claims priority to and the benefit of U.S. Provisional Patent Application Ser. No. 62/513,402, entitled “Systems and Apparatuses for Rich Phrase Extraction” and filed on May 31, 2017, the entire contents of which are hereby incorporated by reference.

### TECHNOLOGICAL FIELD

The present invention relates to analyzing real estate property descriptions, and more specifically, to extracting phrases from the real estate property descriptions, calculating a score, using natural language understanding, by comparing the phrases from the real estate property descriptions with similar property listing descriptions, and promoting real estate property descriptions based on the score.

### BACKGROUND

The process of searching for a new home or renting an apartment is a major undertaking for a potential home buyer or renter and often includes repetitive, boring browsing at hundreds of property listings. As such, it is important for real estate agents/advertisers to not only write and be able to describe rental properties in a way that is impactful, persuasive, and appeal to readers, but the rental property descriptions must also be showcased in the forefront so as to be better exposed to the potential home buyer or renter.

As described in detail below, the inventors have developed a versatile service via a smart algorithm for studying numerous real estate property descriptions, extracting phrases describing unique features by comparing the extracted phrases with similar house features, calculating a score for each real estate property description, and providing a suggested list of property descriptions with the highest scores to be presented to consumers. Accordingly, this service may provide for more engaging real estate listings for presentation which summarize key features of the property while still using the exact language written by the real estate agent.

### BRIEF SUMMARY

Apparatuses, methods, and systems disclosed herein that extracts grammatically meaningful phrases from property listing descriptions. In one example embodiment, a method is provided comprising receiving property descriptions, identifying phrase candidates by: parsing each phrase candidate into a set of word tokens, tagging each word token, and grouping the set of word tokens. Thereafter, computing a score for each phrase candidate and providing a list of property description recommendations comprising one or more phrase candidates with a high ranking score. The method further comprises predicting, via a machine learning algorithm, future trend value of each of the property description recommendations based on results from a plurality of historical property descriptions, and causing to display the list of property description recommendations in an order according to the predicted future trend value.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is an example block diagram of example components of the Praisizz service technology system that may support example embodiments of the present invention;

FIG. 2 is an example block diagram of an example computing device for practicing embodiments of the Praisizz service technology and the example Praisizz service technology system that may support example embodiments of the present invention;

FIG. 3 is a flowchart illustrating operations performed by the computing device for practicing embodiments of the Praisizz service technology in accordance with example embodiments of the present invention;

FIGS. 4 and 5 are schematic representations of user interfaces which may be displayed in accordance with example embodiments of the present invention;

FIG. 6 is a flowchart illustrating operations performed by the Candidate Extraction Pipeline module in accordance with example embodiments of the present invention;

FIG. 7 is a flowchart illustrating operations performed by the Phrase Scoring Pipeline engine in accordance with example embodiments of the present invention;

FIG. 8 are schematic representations of a property description and stopwords in accordance with example embodiments of the present invention;

FIG. 9 is a schematic representation of parts of speech tagging and a grammar rule example in accordance with example embodiments of the present invention;

FIG. 10 is a schematic representation of real estate keyword buckets in accordance with example embodiments of the present invention; and

FIG. 11 is a schematic representation of phrase, sentence & property scoring in accordance with example embodiments of the present invention;

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., one or more volatile or non-volatile memory device), can be differentiated from a “computer-readable transmission medium,” which refers to an electromagnetic signal.

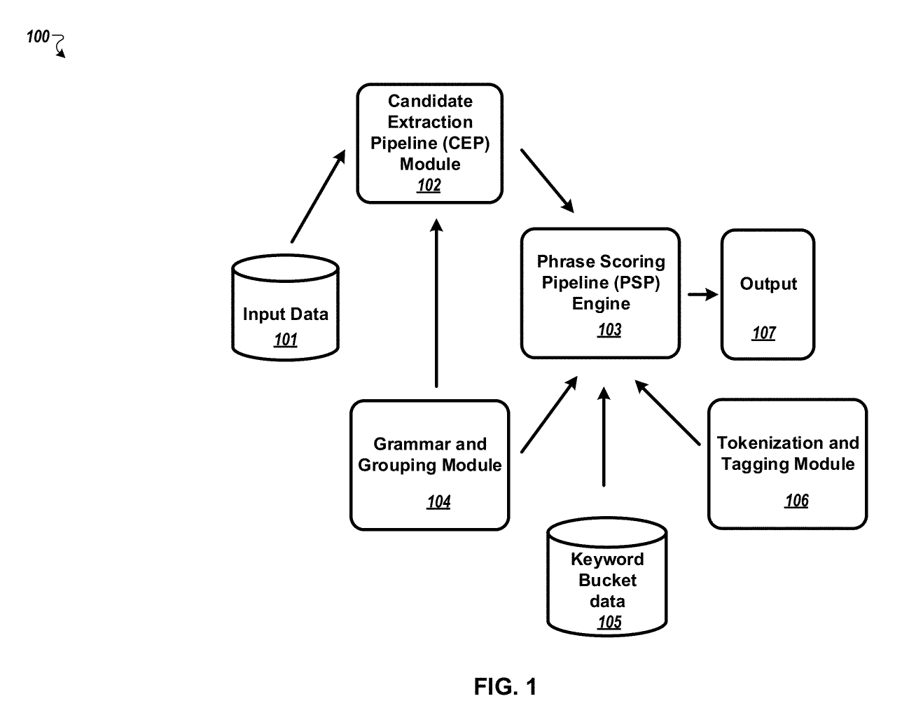

Reference is now made to FIG. 1 which is an example block diagram of example components of the Praisizz service technology system that may support example embodiments of the present invention. In some example embodiments, the Praisizz service technology system 100 comprises a candidate extraction pipeline (CEP) module 102, keyword bucket data 105, a phrase scoring pipeline (PSP) engine 103, a grammar and grouping module 104, and a tokenization and tagging module 106. The CEP module 102, PSP engine 103, grammar and grouping module 104, and tokenization and tagging module 106 may take the form of, for example, a code module, a component, circuitry and/or the like. The components of the Praisizz service technology system 100 are configured to provide various logic (e.g. code, instructions, functions, routines and/or the like) and/or services related to the Praisizz service technology system 100.

In some examples, the keyword bucket data 104 comprises bucket words which are words related to real estate property elements and different variations. For example, one bucket may be “entry” with variations such as “entry,” “foyer,” “entrance,” “entryway,” and the like. Another bucket may be “staircase” with variations such as “staircase,” “stairs,” and the like. Yet another example may be a bucket for “cabinet” with “cabinets,” “cabinetry,” and the like identified as variations for example. In some embodiments, the bucket word is a root word with different variations identifying and tied to the bucket word. In some examples, the keyword bucket data 104 may be obtained and/or stored and updated. Alternatively or additionally, the keyword bucket data may be labeled and associated with a particular geographic region. For example, a keyword bucket pool may be tied to a particular region of the United States such as Florida in which there is a high percentage of real estate properties with pools. In an example embodiment, the CEP module is configured to ignore any phrases that do not map to bucket data.

In an example embodiment, the candidate extraction pipeline (CEP) module 102 is configured to access input data 101, wherein the input data represents one or more property descriptions which may be past or present. The CEP module 102 is also configured to, along with the grammar and grouping module 104, identify poor grammar and apply grammar pattern rules in order to extract phrases that are grammatically correct and self-describing. In another embodiment the CEP module 102 is configured to tag each word as a token and group words/tokens into meaningful phrases/candidate data.

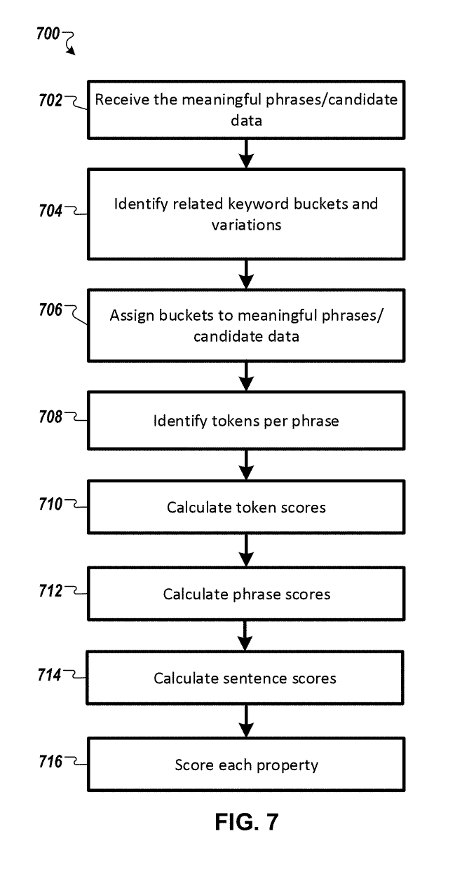

FIG. 1 also illustrates a phrase scoring pipeline (PSP) engine 103. The PSP engine 103 is configured to receive the candidate data from the CEP module 102, the keyword bucket data 105, and results from the grammar grouping module 104 and tokenization tagging module 106 to calculate scores for each word/token, property, sentence and phrase. Additional information regarding the functionality of the PSP engine 103 is described with respect to FIG. 7 of the present application.

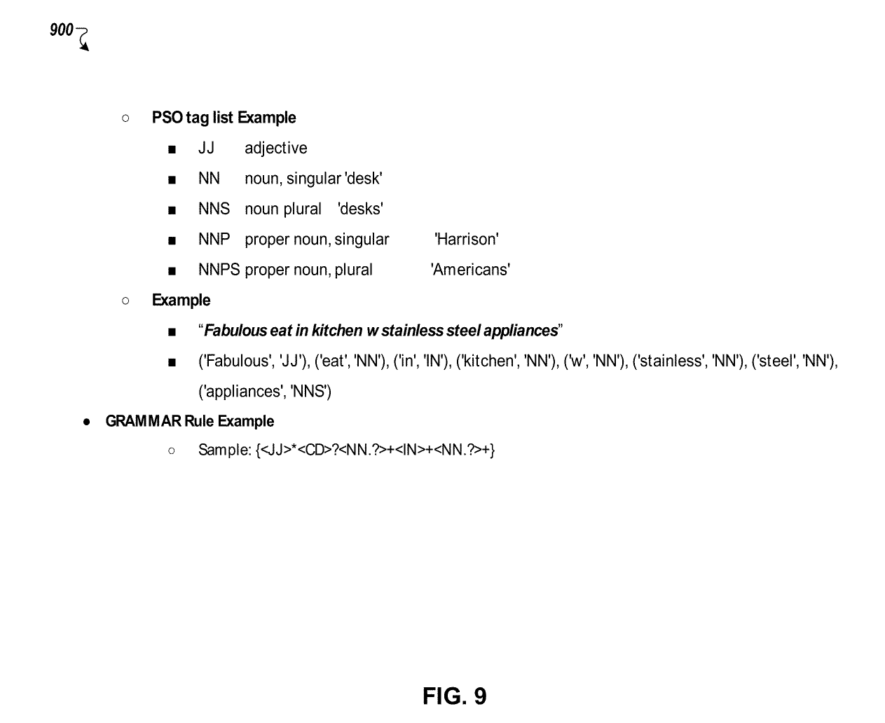

In some embodiments, the tokenization tagging module 106 is configured to apply “part-of-speech” tagging in order to better understand the sentence structure. In some embodiments said “part-of-speech” tagging comprising labeling/tagging words in a sentence as either a noun, adjective, proper noun, etc. In another embodiment, the words may be tagged as singular or plural. For example, in the sentence “Fabulous eat in kitchen w stainless steel appliances,” the tagging comprises: “(Fabulous, JJ), (eat, NN)” where the JJ tag is used to identify adjectives and NN tag is used to identify noun, singular. Although specific tags are used herein, other identifiable tags may be used. In some example embodiments, the tokenization tagging module, the CEP module is configured to identify stop-words and punctuations as a way to parse through property descriptions. Stop words may comprise propositions, conjunctions, pronouns, and the like. A listing of examples of stop words is found in FIG. 9.

The grammar and grouping module 104 is configured to group words into meaningful chunks/phrases. In some embodiments, one of the main goals of chunking is to group into what are known as “noun phrases.” The grammar and grouping module is configured to identify and apply grammar patterns rules. One such example of a grammar pattern rule includes: {<JJ>*<CD>?<NN.?>+<IN>+<NN.?>+} for the example phrase “Fabulous eat in kitchen w stainless steel appliances.”

The Praisizz service technology system 100 is configured, in some examples, to generate an output 107. In some examples, the output may take the form of a JavaScript Object Notation (JSON) output for geographic region. In some examples, the output 107 may be cached in a database and may be displayed, in some examples, via a user interface or transmitted for use by a service or interested party.

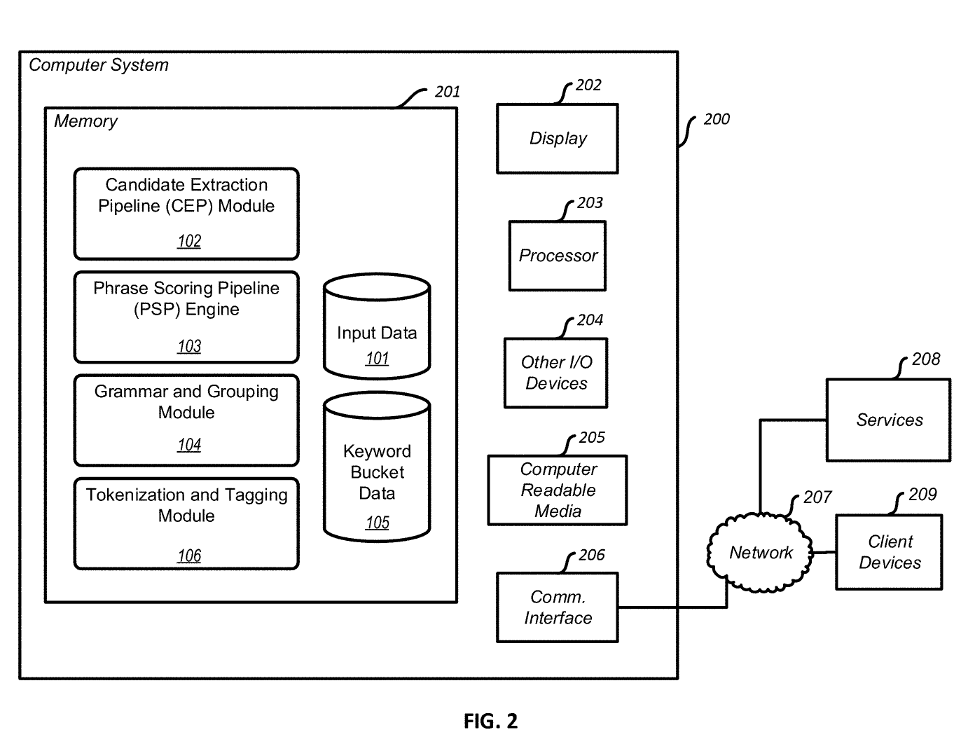

FIG. 2 is an example block diagram of an example computing device for practicing embodiments of the Praisizz service technology system. In particular, FIG. 2 shows a computing system 200 that comprises a candidate extraction pipeline (CEP) module 102, phrase scoring pipeline (PSP) engine 103, grammar and grouping module 104, and tokenization and tagging module 106, input data 101, and keyword bucket data 105.

One or more general purpose or special purpose computing systems/devices may be used to implement the Praisizz service technology system. In addition, the computing system 300 may comprise one or more distinct computing systems/devices and may span distributed locations. In some example embodiments, the candidate extraction pipeline (CEP) module 102, the phrase scoring pipeline (PSP) engine 103, the grammar and grouping module 104, and the tokenization and tagging module 106 may be configured to operate remotely via the network 207. In other example embodiments, a pre-processing module or other module that requires heavy computational load may be configured to perform that computational load and thus may be on a remote device, cloud server, or server. For example, any of the phrase scoring pipeline (PSP) engine 103, the grammar and grouping module 104, and the tokenization and tagging module 106 may be accessed remotely. Furthermore, each block shown may represent one or more such blocks as appropriate to a specific example embodiment. In some cases one or more of the blocks may be combined with other blocks. Also, the phrase scoring pipeline (PSP) engine 103, the grammar and grouping module 104, and the tokenization and tagging module 106 may be implemented in software, hardware, firmware, or in some combination to achieve the capabilities described herein.

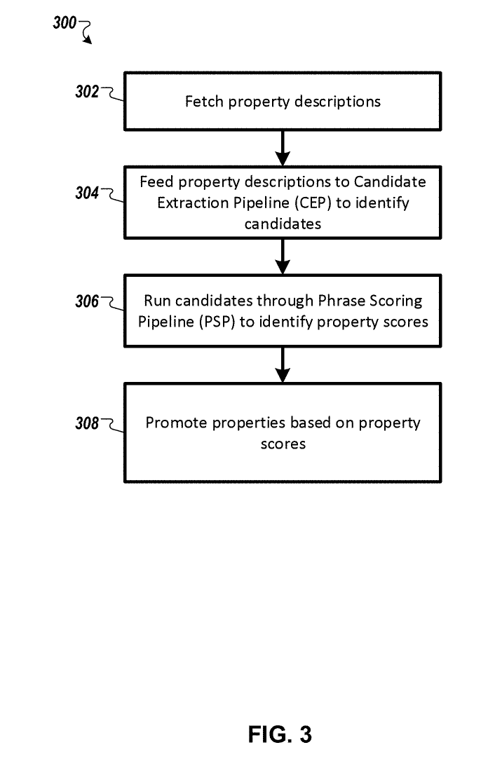

In the example embodiment shown, computing system 200 comprises a display 202, one or more processors 203, input/output devices 204 (e.g., keyboard, mouse, display, touch screen, audio or video output device, gesture sensing device, virtual reality, augmented reality, wearables and/or the like), computer-readable media 205, and communications interface 206. The processor 203 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application-specific integrated circuit (ASIC) or field-programmable gate array (FPGA), or some combination thereof. Accordingly, although illustrated in FIG. 3 as a single processor, in some example embodiments the processor 203 comprises a plurality of processors. The plurality of processors may be in operative communication with each other and may be collectively configured to perform one or more functionalities of the system as described herein.

The phrase scoring pipeline (PSP) engine 103, the grammar and grouping module 104, and the tokenization and tagging module 106 are shown residing in memory 201. The memory 201 may comprise, for example, transitory and/or non-transitory memory, such as volatile memory, non-volatile memory, or some combination thereof. Although illustrated in FIG. 3 as a single memory, the memory 201 may comprise a plurality of memories. The plurality of memories may be embodied on a single computing device or may be distributed across a plurality of computing devices collectively configured to function as the disclosed system. In various example embodiments, the memory 401 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof.

In some examples, computer system 200 may take the form of a cloud service, whereby the phrase scoring pipeline (PSP) engine 103, the grammar and grouping module 104, and the tokenization and tagging module 106 can be activated or otherwise launch on demand and scaled as needed. Accordingly, in such examples, the recited phrase scoring pipeline (PSP) engine 103, the grammar and grouping module 104, and the tokenization and tagging module 106 may be implemented via the cloud, as software as a service, and/or the like.

In other embodiments, some portion of the contents, some or all of the components of the phrase scoring pipeline (PSP) engine 103, the grammar and grouping module 104, and the tokenization and tagging module 106 may be stored on and/or transmitted over the other computer-readable media 205. The components of the phrase scoring pipeline (PSP) engine 103, the grammar and grouping module 104, and the tokenization and tagging module 106 preferably execute on one or more processors 203 and are configured to enable operation of a system, as described herein.

Alternatively or additionally, other code or programs (e.g., an interface for administration, related collaboration projects, a Web server, a Cloud server, a distributed environment, and/or the like) and potentially other data repositories, such as other data sources, also reside in the memory 201, and preferably execute on one or more processors 203. Of note, one or more of the components in FIG. 2 may not be present in any specific implementation. For example, some embodiments may not provide other computer readable media 205 or a display 202.

The phrase scoring pipeline (PSP) engine 103, the grammar and grouping module 104, and the tokenization and tagging module 106 are further configured to provide functions such as those described with reference to FIGS. 1 and 2. The phrase scoring pipeline (PSP) engine 103, the grammar and grouping module 104, and the tokenization and tagging module 106, via the communications interface 206, with services 208 (e.g. real estate data, metrics, and/or the like) and/or client devices 209. The network 209 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX, Bluetooth) that facilitate communication between remotely situated humans and/or devices. In some instance the network 209 may take the form of the internet or may be embodied by a cellular network such as an LTE based network. In this regard, the communications interface 206 may be capable of operating with one or more air interface standards, communication protocols, modulation types, access types, and/or the like. The client devices 209 include desktop computing systems, notebook computers, mobile phones, smart phones, personal digital assistants, tablets, wearables, and/or the like.

In an example embodiment, components/modules of the phrase scoring pipeline (PSP) engine 103, the grammar and grouping module 104, and the tokenization and tagging module 106 are implemented using standard programming techniques. For example, the phrase scoring pipeline (PSP) engine 103, the grammar and grouping module 104, and the tokenization and tagging module 106 may be implemented as a “native” executable running on the processor 203, along with one or more static or dynamic libraries. In other embodiments, the phrase scoring pipeline (PSP) engine 103, the grammar and grouping module 104, and the tokenization and tagging module 106 may be implemented as instructions processed by a virtual or other remote operation machine that executes as one of other programs. In general, a range of programming languages known in the art may be employed for implementing such example embodiments, including representative implementations of various programming language paradigms, including but not limited to, object-oriented (e.g., Delphi, Java, C++, C#, Visual Basic.NET, Smalltalk, and the like), functional (e.g., Clojure, ML, Wolfram, Lisp, Scheme, and the like), procedural (e.g., C, Go, Fortran, Pascal, Ada, Modula, and the like), scripting (e.g., Perl, Ruby, Python, JavaScript, VBScript, and the like), and declarative (e.g., SQL, Prolog, and the like). Although, various programming languages are listed herein, the invention may be implemented in any language known in the art.

The embodiments described above may also use synchronous or asynchronous client-server computing techniques. Also, the various components may be implemented using more programming techniques, for example, as an executable running on a single processor computer system, or alternatively decomposed using a variety of structuring techniques, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the phrase scoring pipeline (PSP) engine 103, the grammar and grouping module 104, and the tokenization and tagging module 106, such as by using one or more application programming interfaces can be made available by mechanisms such as through application programming interfaces (API); libraries for accessing files, databases, or other data repositories; through scripting languages such as XML; or through Web servers, FTP servers, or other types of servers providing access to stored data. The input data 101 and keyword bucket data 105 may be implemented as one or more database systems, file systems, or any other technique for storing such information, or any combination of the above, including implementations using distributed computing techniques. Alternatively or additionally, the keyword bucket data 105 and input data 105 may be local data stores but may also be configured to access data from a service 208.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the phrase scoring pipeline (PSP) engine 103, the grammar and grouping module 104, and the tokenization and tagging module 106 may be implemented or provided in other manners, such as at least partially in firmware and/or hardware, including, but not limited to one or more ASICs, standard integrated circuits, controllers executing appropriate instructions, and including microcontrollers and/or embedded controllers, FPGAs, complex programmable logic devices (“CPLDs”), and the like. Some or all of the system components and/or data structures may also be stored as contents (e.g., as executable or other machine-readable software instructions or structured data) on a computer-readable medium so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

FIGS. 3 and 6-8 illustrate example flowcharts of the operations performed by an apparatus, such as computing system 200 of FIG. 2, in accordance with example embodiments of the present invention. It will be understood that each block of the flowcharts, and combinations of blocks in the flowcharts, may be implemented by various means, such as hardware, firmware, one or more processors, circuitry and/or other devices associated with execution of software including one or more computer program instructions. For example, one or more of the procedures described above may be embodied by computer program instructions. In this regard, the computer program instructions which embody the procedures described above may be stored by a memory 201 of an apparatus employing an embodiment of the present invention and executed by a processor 203 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 6-8, when executed, convert a computer or processing circuitry into a particular machine configured to perform an example embodiment of the present invention. Accordingly, the operations of FIGS. 3 and 6-8 define an algorithm for configuring a computer or processor, to perform an example embodiment. In some cases, a general purpose computer may be provided with an instance of the processor which performs the algorithm of FIGS. 3 and 6-8 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts', and combinations of blocks in the flowchart, can be implemented by special purpose hardware-based computer systems which perform the specified functions, or combinations of special purpose hardware and computer instructions.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

FIG. 3 is a flowchart illustrating high-level example operations performed by the computing device for practicing embodiments of the Praisizz service technology in accordance with example embodiments of the present invention. In block 302, phrase scoring pipeline (PSP) engine 103 and/or candidate extraction pipeline (CEP) module 102 are configured to access and fetch property descriptions for feeding into the CEP module 102 so as to provide for the extraction and parsing of meaningful phrases to identify rich phrases candidates (block 304). Thereafter, identify and associate the candidate words and/or phrases with specific elements of a property/home (e.g., kitchen, yard, roof, fireplace, stairs, and the like). Using a the PSP engine 103, scoring the property against a potential home buyer or renter's geographic contextual information and/or identified preferences using the identified rich phrases derived from the CEP module 102. In some examples, the property descriptions may be associated with descriptive data, such as location, price, detailed description, price, etc. Some embodiments may resemble commonly presented property descriptions presented via real estate web sites.

In block 306, the rich phrases candidates are run through the PSP engine 103 to identify and score the properties associated with the rich phrases candidates. Details on scoring via the phrase scoring pipeline (PSP) engine 103 will be described in reference with FIG. 7. In some embodiments, based on the property score, the associated property may be promoted such as being relocated to the forefront of a webpage display, highlighted, and/or suggested in order to provide a better user experience when browsing hundreds of property listings. In another embodiment, the identified high scoring phrases may be notated with JavaScript Object Notation (JSON) and cached in a database.

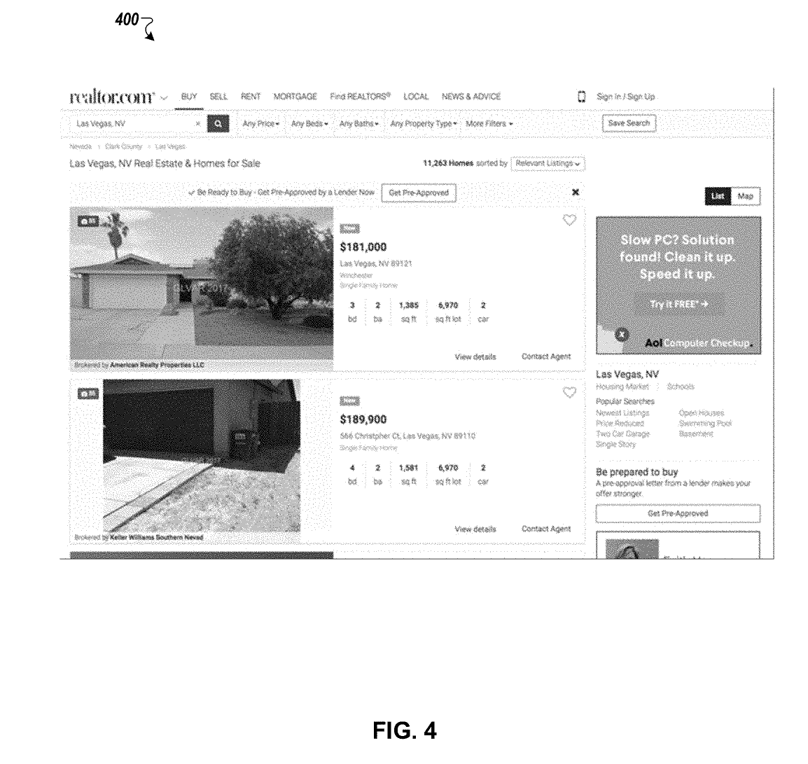

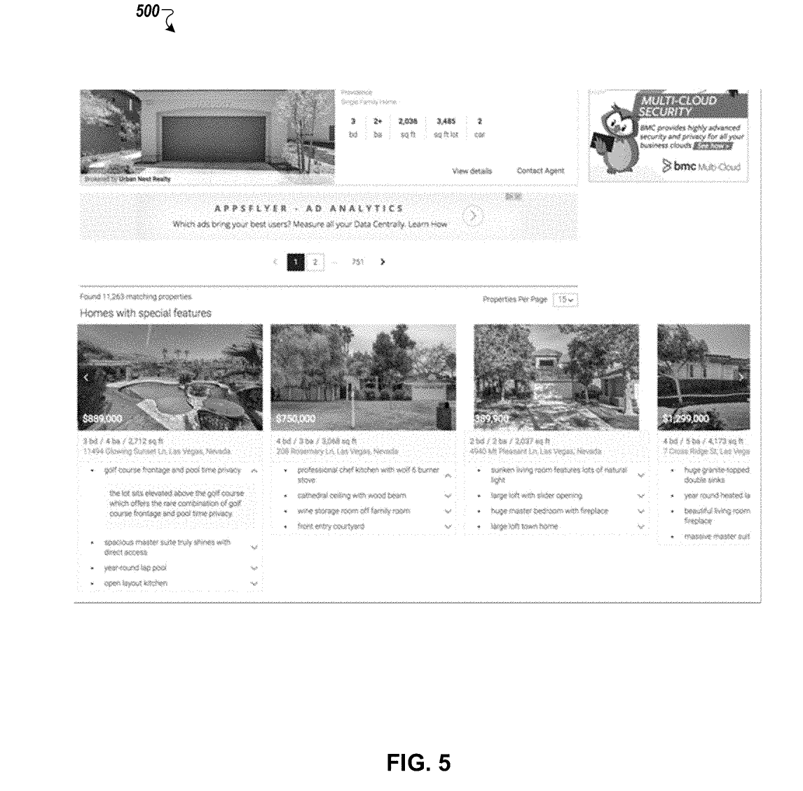

Returning to the specific operations of the system 200, the system provides a series of possible presentations for promoting a particular property based on its score. Image 400 of FIG. 4 displays two listings for the Las Vegas, Nev. location. As one might see, the two listings display basic property information such as price, property type, number of bedrooms/baths, and property square feet. In contrast, Image 500 of FIG. 5 displays the results of the rich phrasing algorithm extraction and scoring. Each listing on the figure comprises rich phrasing that better promotes the property and entices the user to click on them.

Certain embodiments of the phrase scoring pipeline (PSP) engine 103 may be further configured to train the rich phrasing algorithm based on the results of the rich phrasing algorithm extraction and scoring. The PSP engine is configured to determine the importance of each property feature based on a plurality of historical, previously written descriptions. The raw data from the historic written descriptions is then fed into a machine learning model, wherein each model is associated with a geographic region, city, state and/or the like.

The PSP engine 103 then extracts phrases from those property listings with the highest trend value (e.g., popularity) based on the predictive model. The highest trend value may be measured by number of views of the property listing, number of appearances in search results, market data related to the property listing and surrounding geographic region, or the like. Additionally, the predictive models may also provide future trends related to property features based on the extracted phrases from those property listings with the highest trend value. For example, a new property may emerge as a featured property because its property features closely match property features of other popular homes. The PSP engine 103 is then configured to cause to display a list of new property descriptions in an order according to the predicted future trend value.

In certain embodiments, the PSP engine 103 is then configured to utilize the models in the operations with regards to tagging new listings with rich phrases. Each rich phrase may be tagged to enable translation into a phrase with the same core meaning so a rich phrase in one description may be retrieved in response to a search for a phrase with the same core meaning. For example, when a new listing is created, the PSP engine 103 is configured to apply the appropriate model based on the geographic location of the listing. As such, the PSP engine 103 may be configured to tag rich phrases with special identifiers to enable retrieval of a rich phrase from a description to match a phrase with the same core meaning in a different description.

In certain embodiments, relevance is measured based on additional features of the property (e.g., swimming pool, basement, backyard patio, etc.) and the grammatical validity of such feature phrases using crowd sourcing. In this way, a user may be presented with the new listing in a grammatical output with appropriate language, format, etc. according to the location of the user (e.g., the country, city, state, or region that the user is located).

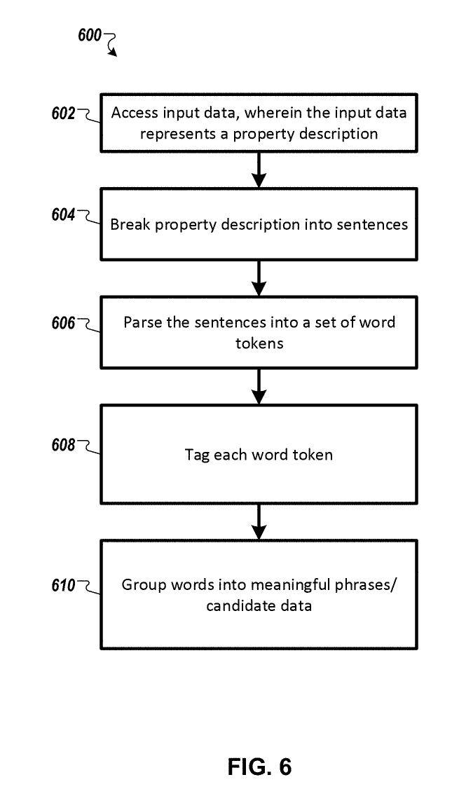

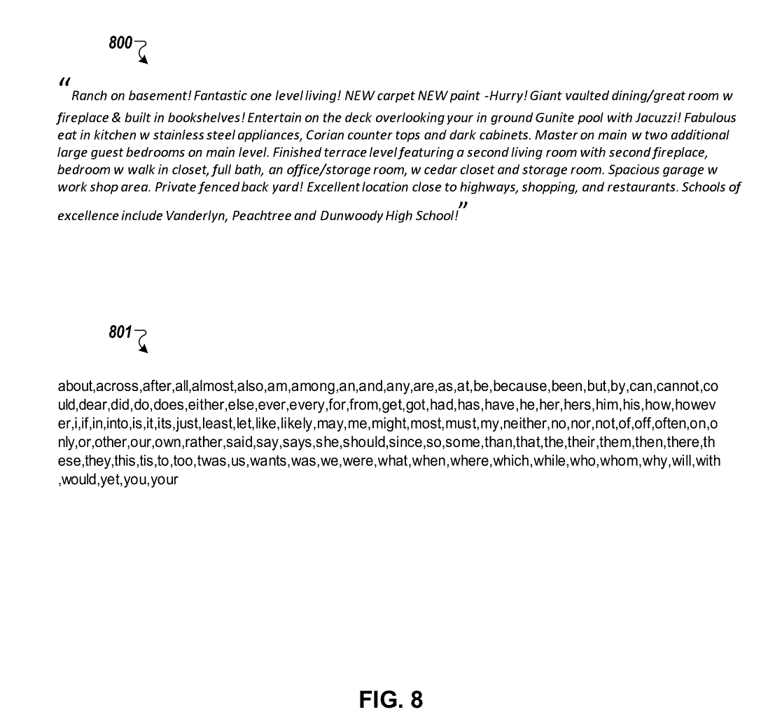

FIG. 6 is a flowchart illustrating operations performed by the Candidate Extraction Pipeline module in accordance with example embodiments of the present invention. In block 602, the CEP module is configured to access input data, wherein the input data represents a property description. An example of a property description is shown as image 800 on FIG. 8. In some example embodiments, the CEP module may query a database based on geographic location and/or property element (e.g., pool, fence, yard, etc.) to retrieve a list of properties for rich phrasing extraction and generation.

The CEP module is configured to prepare the candidate rich phrases by breaking down the descriptions into sentences, applying custom grammar rules, and thereafter extracting meaningful phrases. In some embodiments the CEP module is configured to identify stop-words and punctuations so as to easily identify all meaningful phrases which may be good candidate for the rich phrases. Examples of stop words are depicted in 801 of FIG. 8. The stop-words and punctuations may be filtered out and not used in scoring the phrases.

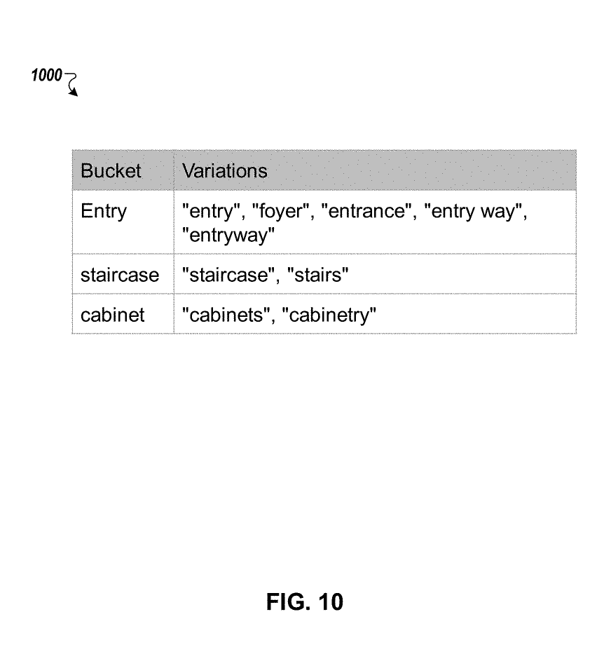

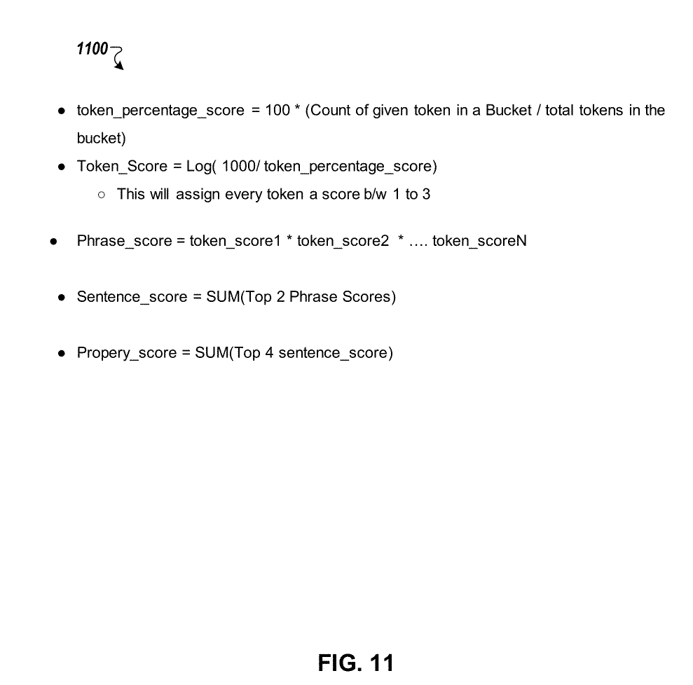

In block 604, the property description is broken into sentences. In some embodiments, the CEP module is configured to recognize sentences based on common delimiters (e.g., punctuation mark, special symbol, digit, letter, etc). Thereafter, the CEP module is configured to parse the sentences into a set of word tokens (block 606). In some embodiments the CEP module is configured to tokenize phrases into words and for each word count its frequency within the bucket word. An example of bucket and variations is depicted in FIG. 10.

In block 608, the CEP module is configured to tag each word token so as to understand the sentence structure. In some embodiments as depicted in FIG. 9, the CEP module is configured to apply parts of speech (POS) tagging which is a process of tagging each word token as a particular part of speech based on its definition and context. Examples tags include adjective, noun-singular, noun-plural, proper noun-singular, proper noun-plural, etc. An example tag list and tagged phrase is depicted in FIG. 9. In some embodiments, the CEP module and/or PSP engine is configured to apply grammar rules in a manner that enhances a phrase's readability. FIG. 9 shows one such example of a grammar rule.

Additionally or alternatively, a specialized tool is configured to visualize all the grammar rules applied to each part of the property description so as to prioritize the application and/or order of the grammar rules.

In block 610, the CEP module is configured to group words into meaningful phrases/candidate data in preparing for scoring and identification of the unique features distinguishing each property. In some embodiments, unique word tokens may be combined so as to present property phrases relevant to a viewer based on his or her geographic region.

In certain embodiments, the CEP module is configured to calculate an importance value of each property phrase by evaluating the change in frequency of co-occurrence of constituent word tokens from each phrase over a predetermined period of time within the same geographic region (e.g., city, state, region, county). In other words, the CEP module takes into account whether the word tokens used in such property descriptions are popular, trending up.

FIG. 7 is a flowchart illustrating operations performed by the PSP engine in accordance with example embodiments of the present invention. As described above, the CEP module is configured to prepare and tokenize phrases from the property description 800. The resulting meaningful phrases/candidate data is received by the PSP engine (block 702). The PSP engine is configured to identify related keyword bucket and variations (block 704) and assign buckets to the meaningful phrases/candidate data (block 706).

In block 708, the PSP engine is configured to identify tokens per phrase and calculate token scores (block 710). In some embodiments, the PSP engine is configured to calculate phrase scores (block 712), and calculate sentence scores (block 714). From these scores, the PSP engine is configured to score each property.

For each city or geographic identifier associated with the property description, calculating score phrases comprises calculating the number of occurrences per 100 tokens in a bucket; assign a score between 1 and 3 as log(100/N). For example, N=1 score 3, N=10, score 2. The PSP engine is then configured to multiply each token's score to assign a phrase score. In another embodiment the PSP engine when scoring sentences is configured to add the score of the top two phrases. The PSP engine is configured to score properties by adding the score of the top 4 sentences (Ps) and by counting number of sentences with a score>media sentence score (Pn).

Additionally, the PSP engine will sort and filter properties by Pn and then by Ps; and thereafter, filter top N properties (N=20). The resulting output may be a generated JSON for each city or geographic identifier. In another embodiment, for example and as depicted in FIG. 12, a token_percentage_score is calculated by multiplying the count of given tokens in a bucket divided by total tokens in the bucket by 100. The token_score is derived by Log(1000/token_percentage_score). This will assign every token a score between 1 to 3, with a high word frequency having a low score and a low word frequency having a high score. As described above each property score may be calculated by the PSP engine with example calculations as depicted in FIG. 12 and described above. As such, in some embodiments, phrases are scored based on geographic uniqueness with higher scores based on uniqueness so as to identify meaningful phrases that may attract home buyers and renters.

Certain embodiments of the inventions may cause to display highlighted properties indicating properties having special property features. In such embodiment, the PSP engine is further configured to rank and/or filter properties according to a special property feature score within the user's location. The PSP engine may calculate a property's special property feature score according to comparable properties relative to the property and estimate a property value based on the comparable property characteristics. In one implementation, the estimated value is based on a weighted average of the number of special property features contained in a property description.

In yet another example embodiment of the invention, the PSP engine is further configured to analyze keywords used in search engines to identify property features popular or in high demand from users. Based on this insight, the PSP engine may update the property value so as to prioritize certain properties with features that are popular based on search engine data. Additionally, the PSP engine is configured to create an ontology of tags to make properties searchable by said property features. For example, features may be combinable within a single search via ontology tags (e.g., searching for “outdoor pool” will also provide search results for “infinity edge pool,” “nearby community pool,” “large lot to build pool”).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving property descriptions;
identifying phrase candidates by:
parsing each phrase candidate into a set of word tokens;
tagging each word token; and
grouping the set of word tokens;
computing a score for each phrase candidate;
providing a list of property description recommendations comprising one or more phrase candidates with a high ranking score;
predicting, via a machine learning algorithm, future trend value of each of the property description recommendations based on results from a plurality of historical property descriptions; and
causing to display the list of property description recommendations in an order according to the predicted future trend value.

2. The method of claim 1, wherein tagging each word token comprises identifying a sentence structure associated with the word token and labeling each word token based on the identified sentence structure.

3. The method of claim 1, wherein computing the score for each phrase candidate comprises calculating a number of occurrences of each word token.

4. The method of claim 1, wherein the set of word tokens are grouped into meaningful phrases based on a set of grammar rules.

5. The method of claim 1, wherein identifying phrase candidates further comprises identifying stop-words.

6. The method of claim 1, further comprising assigning property elements to the set of word tokens.

7. An apparatus comprising at least one processor and at least one memory, the memory comprising instructions that, when executed by a processor, configure the apparatus to:
receive property descriptions;
identify phrase candidates by:
parsing each phrase candidate into a set of word tokens;
tagging each word token; and
grouping the set of word tokens;
compute a score for each phrase candidate;
provide a list of property description recommendations comprising one or more phrase candidates with a high ranking score;
predict, via a machine learning algorithm, future trend value of each of the property description recommendations based on results from a plurality of historical property descriptions; and
cause to display the list of property description recommendations in an order according to the predicted future trend value.

8. The apparatus of claim 7, wherein tagging each word token comprises identifying a sentence structure associated with the word token and labeling each word token based on the identified sentence structure.

9. The apparatus of claim 7, wherein computing the score for each phrase candidate comprises calculating a number of occurrences of each word token.

10. The apparatus of claim 7, wherein the set of word tokens are grouped into meaningful phrases based on a set of grammar rules.

11. The apparatus of claim 7, wherein identifying phrase candidates further comprises identifying stop-words.

12. The apparatus of claim 7, further comprising assigning property elements to the set of word tokens.

13. A computer program product comprising a non-transitory computer readable storage medium, the non-transitory computer readable storage medium comprising instructions that, when executed by a device, configure the device to:
receive property descriptions;
identify phrase candidates by:
parsing each phrase candidate into a set of word tokens;
tagging each word token; and
grouping the set of word tokens;
compute a score for each phrase candidate;
provide a list of property description recommendations comprising one or more phrase candidates with a high ranking score;
predict, via a machine learning algorithm, future trend value of each of the property description recommendations based on results from a plurality of historical property descriptions; and
cause to display the list of property description recommendations in an order according to the predicted future trend value.

14. The computer program product of claim 13, wherein tagging each word token comprises identifying a sentence structure associated with the word token and labeling each word token based on the identified sentence structure.

15. The computer program product of claim 13, wherein computing the score for each phrase candidate comprises calculating a number of occurrences of each word token.

16. The computer program product of claim 13, wherein the set of word tokens are grouped into meaningful phrases based on a set of grammar rules.

17. The computer program product of claim 13, wherein identifying phrase candidates further comprises identifying stop-words.

18. The computer program product of claim 13, further comprising assigning property elements to the set of word tokens.
